(19) United States
(12) Patent Application Publication
(10) Pub. No.: US 2022/0167585 A1
(43) Pub. Date: Jun. 2, 2022

(54) Whirlpool water flowing device

(71) Applicant: Daofen WEI, Zhangjiajie (CN)

(72) Inventor: Daofen WEI, Zhangjiajie (CN)

(21) Appl. No.: 17/149,827

(22) Filed: Jan. 15, 2021

(30) Foreign Application Priority Data
Nov. 30, 2020 (CN) 202011380730.0

(51) Int. Cl. A01K 7/02; F15D 1/00

(52) U.S. Cl. CPC A01K 7/02; F15D 1/00

(57) ABSTRACT

The invention discloses a vortex water flowing device, which comprises a basin body, wherein the top of the basin body is provided with an inner concave area with a smooth downward concave arc surface, a water leakage hole is arranged at the lowest point of the inner concave area, a spiral diversion groove from bottom to top and from inside to outside is arranged on the inner wall of the inner concave area, and a water outlet is arranged at the top of the basin body corresponding to the highest point of the diversion groove.

### CROSS REFERENCE TO RELATED APPLICATION

The present application claims priority to China patent application No. 202011380730.0, entitled “WHIRLPOOL WATER FLOWING DEVICE”, filed on Nov. 30, 2020, the entire content of which is incorporated herein by reference.

### TECHNICAL FIELD

The invention relates to the technical field of drinking water devices, in particular to a vortex flow device.

### BACKGROUND INFORMATION

In the process of drinking water, pets prefer to drink water with strong fluidity. However, the existing pet water supply device either cannot provide flowing water or even provides flowing water, and the flowing water has small flowing range and monotonous effect, which is difficult to arouse pets' interest, or the flowing water splashes, causing pets to panic and affecting the cleanliness of the home. Not only can't induce pets to drink water, but it will also cause troubles to owners.

### INVENTION CONTENT

The technical problem to be solved by the invention is to overcome the defects of the prior art and provide a vortex flowing water device which is simple and practical, has strong water body fluidity, good water flow stability and can effectively improve the drinking interest of pets.

To solve the above technical problems, the technical scheme proposed by the present invention is as follows

A vortex water flowing device comprises a basin body, wherein the top of the basin body is provided with an inner concave area with a smooth concave arc surface; the lowest point of the inner concave area is provided with a water leakage hole; the inner wall of the inner concave area is provided with a spiral diversion groove from bottom to top and from inside to outside; and the top of the basin body is provided with a water outlet corresponding to the highest point of the diversion groove.

As a further improvement of the above technical scheme:

The concave area is hemispherical.

The upper edge of the concave region is provided with a water retaining edge, and the height of the water retaining edge is higher than that of the water outlet and lower than the water retaining wall.

The top surface of the basin body is also provided with an overflow hole, and the height of the overflow hole is higher than the water retaining edge and lower than the retaining wall.

The vortex water flowing device also comprises a base, wherein the basin body is detachably covered on the top of the base; a water pump and a water storage space communicated with the water leakage hole are arranged in the base; and the inlet of the water pump is communicated with the water storage space, and the outlet is communicated with the water outlet.

The wall surface of the base is also provided with an observation window made of transparent material and used for displaying the water storage space.

The bottom of the basin body is provided with a filtering device covering the water leakage hole.

The bottom surface of the basin body is provided with a snap ring at the periphery of the water leakage hole; The filter device has a barrel-shaped structure, a filter hole is arranged on the bottom surface, a convex edge matched with the snap ring is arranged at the edge of the top opening, and the convex edge is detachably clamped at the snap ring.

Compared with the prior art, the invention has the advantages that:

The vortex water flowing device of the invention comprises a basin body, wherein the top of the basin body is provided with an inner concave area with a smooth concave arc surface, the lowest point of the inner concave area is provided with a water leakage hole, the inner wall of the inner concave area is provided with a spiral diversion groove from bottom to top and from inside to outside, and the top of the basin body is provided with a water outlet corresponding to the highest point of the diversion groove. When the water flows out from the water outlet, it overflows the water retaining edge and flows down gently along the inner wall of the concave area, while the spiral diversion groove guides the flow direction of the water, making the water flow spirally downward along the diversion groove to form a centripetal force. When the water reaches the lowest point, one part flows out from the water leakage hole, while the other part slowly gathers at the bottom, forming a vortex flow pattern due to the centripetal force, and finally forming a water surface with more and more water. And a stable vortex is formed on the water surface, the whole process has strong fluidity of water body, vivid flow track, strong ornamental and interesting, and can effectively attract pets' interest in drinking water. Considering the water flow is limited by the smooth concave curved surface and the diversion groove, there is no impact point on the flow track, so the possibility of splashing is eliminated, avoided the pet panic, so that the household cleanliness is not affected at the same time with the excellent use effect.

### BRIEF DESCRIPTION OF ATTACHED DRAWINGS

FIG. 1 is a schematic view of a three-dimensional structure of a vortex flow apparatus of the present invention

FIG. 2 is a schematic diagram of the top structure of the vortex flow device of the present invention

FIG. 3 is a schematic diagram of the internal structure of the vortex flow device of the present invention

Illustration: 1. Pot body; 11, concave area; 111, water leakage hole; 112, diversion trough; 113, block the water; 12. Water outlet; 13. retaining wall; 14. overflow hole; 15. Filter device; 2. Base; 21. Water pump; 22. Water storage space; 23. observation window.

### Specified Implementation Mode

In order to facilitate an understanding of the present invention, the present invention will be described more fully and in detail below with reference to the accompanying drawings and preferred embodiments of the specification, but the scope of protection of the present invention is not limited to the following specific implementation examples.

### EXAMPLES

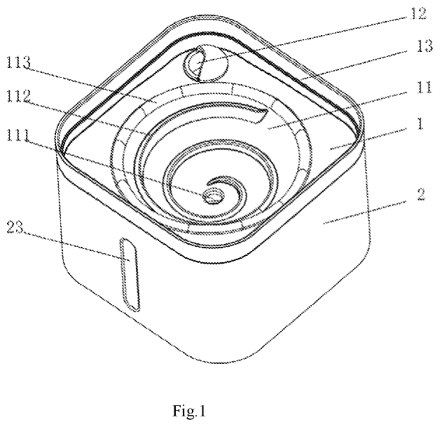

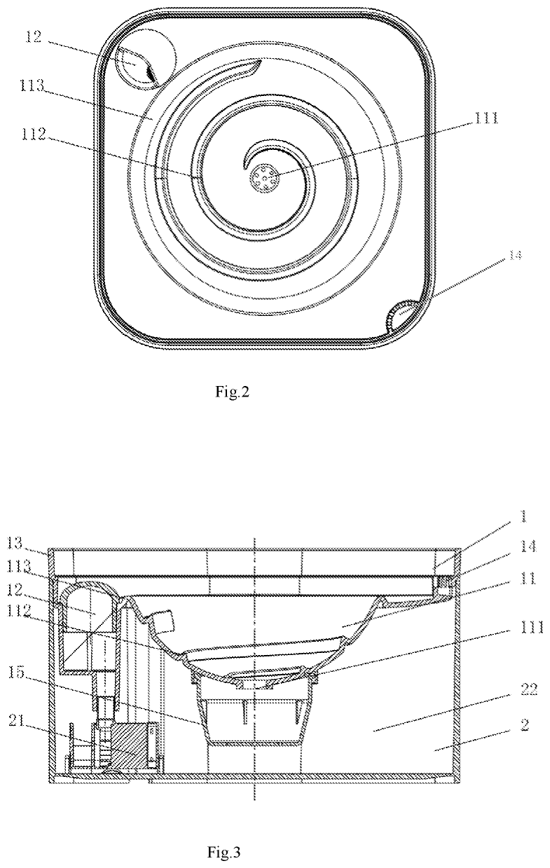

As shown in FIG. 1 to FIG. 3, the vortex water running device of this specific implementation example includes a basin body 1, the top of which is provided with a concave area 11 with smooth concave arc surface, the lowest point of the concave area 11 is provided with a water leakage hole 111, and the inner wall of the concave area 11 is provided with a spiral guide groove 112 from bottom to top and from inside to outside, as shown in FIG. 2. A water outlet 12 is provided at the top of the basin body 1 at a position corresponding to the highest point of the diversion groove 112. When the water flows out from the water outlet 12, it overflows the water retaining edge 113 and flows down gently along the inner wall of the concave area 11, while the spiral guide groove 112 guides the flow direction of the water, which makes the water flow spirally downward along the guide groove 112 to form a centripetal force. When the water reaches the lowest point, one part flows out from the water leakage hole 111, while the other part slowly gathers at the bottom, forming a vortex flow pattern due to the centripetal force. Finally, a water surface is formed, and a stable vortex is formed on the water surface. In the whole process, the water body has strong fluidity, vivid flow track, strong ornamental and interesting, which can effectively attract pets' interest in drinking water. Moreover, because the water flow is limited by the smooth concave curved surface and the diversion groove 112, there is no impact point on the flow track, so the possibility of splashing is eliminated, and the pet panic is avoided. At the same time, the cleanliness of the home is not affected, and the use effect is good.

In this implementation example, the concave area 11 is hemispherical, so as to adapt to the pet's facial structure and optimize the use feeling.

In this example, the top edge of the basin body 1 is provided with a protruding retaining wall 13, and the upper edge of the concave area 11 is provided with a water retaining edge 113, the height of which is higher than the water outlet 12 and lower than the retaining wall 13. The arrangement of the water retaining edge 113 can prevent the water from rushing into the inner wall of the concave area 11 due to its own initial velocity, but overflow through the water retaining edge 113 and then gently flow into the inner wall of the concave area 11, and spiral downward under the action of the diversion groove 112 to form a centripetal force, which can reduce the initial velocity of the water flowing out of the water outlet 12 and avoid affecting the centripetal force formed by diversion of the diversion groove 112.

In this example, the top surface of the basin body 1 is also provided with a water overflow hole 14. The height of the water overflow hole 14 is higher than the water retaining edge 113 and lower than the water retaining wall 13, so as to prevent water from overflowing the water retaining wall 13 and causing wetting of the ground.

In this example, the vortex flow device further comprises a base 2, and the basin body 1 is detachably covered on the top of the base 2, which is convenient for disassembly and cleaning The interior of the base 2 is provided with a water pump 21 and a water storage space 22 communicated with the water leakage hole 111, the inlet of the water pump 21 is communicated with the water storage space 22, and the outlet is communicated with the water outlet 12, and the water pump 21 is used for re-guiding the water flow in the water storage space 22 to the water outlet 12, so as to form a water flow circulation and save water consumption.

In this example, the wall surface of the base 2 is also provided with an observation window 23 made of transparent material and used for displaying the water storage space 22, which is convenient for the owner to observe the water quantity in the water storage space 22 for timely supplement.

In this example, the bottom of the basin body 1 is provided with a filtering device 15 which is covered at the water leakage hole 111. Before water flows into the water storage space 22 through the water leakage hole 111 again after circulation, the filtering device 15 can filter impurities such as dust, floating hairs and the like in the water body to ensure water quality.

In this example, the bottom surface of the basin 1 is provided with a snap ring at the periphery of the water leakage hole 111. The filtering device 15 has a barrel-shaped structure, the bottom surface is provided with a filtering hole, the edge of the top opening is provided with a convex edge which is matched and clamped with the snap ring, and the convex edge is detachably clamped at the snap ring. After a certain time elapses, the user can conveniently disassemble the filter device 15 for cleaning and replacement.

The above is only a preferred embodiment of the present invention, and the scope of protection of the present invention is not limited to the above examples. For those skilled in the art, the improvement and transformation obtained without departing from the technical concept of the present invention should also be regarded as the protection scope of the present invention.

What is claimed is:

1. A vortex flow device, comprising a basin body, wherein the top of the basin body is provided with a concave region with a smooth concave arc surface, the lowest point of the concave region is provided with a water leakage hole, the inner wall of the concave region is provided with a spiral guide groove from bottom to top and from inside to outside from the water leakage hole, and the top of the basin body is provided with a water outlet at a position corresponding to the highest point of the guide groove.

2. The vortex flow device according to claim 1, wherein the concave area is hemispherical.

3. The vortex flow device according to claim 1, wherein the top edge of the basin body is provided with a protruding retaining wall, and the upper edge of the concave area is provided with a water retaining edge, and the height of the water retaining edge is higher than the water outlet and lower than the retaining wall.

4. The vortex flow device according to claim 3, wherein the top surface of the basin body is also provided with an overflow hole, and the height of the overflow hole is higher than the water retaining edge and lower than the retaining wall.

5. The vortex flow device according to claim 1, further comprising a base, wherein the basin body is detachably covered on the top of the base; a water pump and a water storage space communicated with a water leakage hole are arranged in the base; an inlet of the water pump is communicated with the water storage space; and an outlet is communicated with a water outlet.

6. The vortex flow device according to claim 5, wherein the wall surface of the base is also provided with an observation window made of transparent material for displaying the water storage space.

7. The vortex flow device according to claim 5, wherein the bottom of the basin body is provided with a filtering device covering the water leakage hole.

8. The vortex flow device according to claim 7, wherein the bottom surface of the basin body is provided with a snap ring at the periphery of the water leakage hole; The filtering device has a barrel-shaped structure, a filter hole is arranged on the bottom surface, a convex edge matched with the snap ring is arranged on the edge of the top opening, and the convex edge is detachably clamped at the snap ring through the convex edge.
